(19) United States
(12) Patent Application Publication
(10) Pub. No.: US 2013/0051695 A1
(43) Pub. Date: Feb. 28, 2013

(54) IMAGE COMPRESSING DEVICE, IMAGE COMPRESSING METHOD, AND IMAGE COMPRESSING PROGRAM

(71) Applicant: Tsuyoshi SASAKI, Yokohama-shi (JP)

(72) Inventor: Tsuyoshi SASAKI, Yokohama-shi (JP)

(73) Assignee: Honda elesys Co., Ltd. of YBP Hi-tech Center, Yokohama-shi (JP)

(21) Appl. No.: 13/598,110

(22) Filed: Aug. 29, 2012

(30) Foreign Application Priority Data
Aug. 30, 2011 (JP) P2011-187800

(51) Int. Cl. G06K 9/36

(52) U.S. Cl. 382/250

(57) ABSTRACT

An image compressing device includes a block generating unit configured to divide an image into blocks having a predetermined size and to generate data corresponding to a plurality of blocks, a discrete cosine transform unit configured to perform a discrete cosine transform on the data corresponding to the plurality of blocks generated by the block generating unit for each block and to generate frequency domain data of the image, and a data adjusting unit configured to extract only components of a limited frequency domain from the frequency domain data of the image generated by the discrete cosine transform unit and to generate compressed data.

### CROSS-REFERENCE TO RELATED APPLICATIONS

Priority is claimed on Japanese Patent Application No. 2011-187800, filed Aug. 30, 2011, the contents of which are entirely incorporated herein by reference.

### BACKGROUND OF THE INVENTION

1. Field of the Invention

The present invention relates to an image compressing device, an image compressing method, and an image compressing program.

2. Description of Related Art

As an image compressing techniques, JPEG and the like have become widespread.

For example, Japanese Unexamined Patent Application, First Publication No. 10-322721 (Patent Document 1) discloses “an image data compressing/expanding method, an information processing device, and a storage medium on which an image data compressing/expanding program is stored” and mentions JPEG therein (see Paragraphs 0017 to 0024 of Patent Document 1).

### SUMMARY OF THE INVENTION

In general, in JPEG, which is widespread as an image compressing technique, the image quality is high, but there are problems in that when a JPEG file is stored in hardware such as an FPGA (Field Programmable Gate Array) or a digital circuit, the circuit resources used increase, whereby it is difficult to store a JPEG file in a small-scale hardware device (such as an FPGA or a digital circuit).

The invention is made in consideration of such circumstances and an object thereof is to provide an image compressing device, an image compressing method, and an image compressing program which can be easily stored in a small-scale hardware device (such as an FPGA or a digital circuit).

According to an aspect of the invention, there is provided an image compressing device including: a block generating unit configured to divide an image into blocks having a predetermined size and to generate data corresponding to a plurality of blocks; a discrete cosine transform unit configured to perform a discrete cosine transform on the data corresponding to the plurality of blocks generated by the block generating unit for each block and to generate frequency domain data of the image; and a data adjusting unit configured to extract only components of a limited frequency domain from the frequency domain data of the image generated by the discrete cosine transform unit and to generate compressed data.

The image compressing device may further include a cutout unit configured to cut out a predetermined part of an image, and the block generating unit may divide the part of the image cut out by the cutout unit into blocks having a predetermined size and may generate data corresponding to a plurality of blocks.

According to another aspect of the invention, there is provided an image compressing device including: a vertical division unit configured to divide an image into an upper part and a lower part; a first image compressing unit configured to compress the image of the upper part output from the vertical division unit; a second image compressing unit configured to compress the image of the lower part output from the vertical division unit; and a vertical combination unit configured to combine compressed data of the image of the upper part generated by the first image compressing unit and compressed data of the image of the lower part generated by the second image compressing unit, wherein the first image compressing unit includes a first block generating unit configured to divide the image of the upper part output from the vertical division unit into blocks having a predetermined size and to generate data corresponding to a plurality of blocks, a first discrete cosine transform unit configured to perform a discrete cosine transform on the data corresponding to the plurality of blocks generated by the first block generating unit for each block and to generate frequency domain data of the image, and a first data adjusting unit configured to extract only components of a limited frequency domain from the frequency domain data of the image generated by the first discrete cosine transform unit and to generate compressed data, wherein the second image compressing unit includes a second block generating unit configured to divide the image of the lower part output from the vertical division unit into blocks having a predetermined size and to generate data corresponding to a plurality of blocks, a second discrete cosine transform unit configured to perform a discrete cosine transform on the data corresponding to the plurality of blocks generated by the second block generating unit for each block and to generate frequency domain data of the image, and a second data adjusting unit configured to extract only components of a limited frequency domain from the frequency domain data of the image generated by the second discrete cosine transform unit and to generate compressed data, and wherein the limited frequency domain specified by the first data adjusting unit of the first image compressing unit and the frequency domain specified by the second data adjusting unit of the second image compressing unit are different from each other.

The image compressing device may be configured to compress an image captured by an in-vehicle camera.

According to still another aspect of the invention, there is provided an image compressing method including: a step of dividing an image into blocks having a predetermined size and generating data corresponding to a plurality of blocks; a step of performing a discrete cosine transform on the data corresponding to the plurality of blocks for each block and generating frequency domain data of the image; and a step of extracting only components of a limited frequency domain from the frequency domain data of the image and generating compressed data.

According to still another aspect of the invention, there is provided an image compressing program causing a computer to execute: a block generating sequence of dividing an image into blocks having a predetermined size and generating data corresponding to a plurality of blocks; a discrete cosine transform sequence of performing a discrete cosine transform on the data corresponding to the plurality of blocks generated in the block generating sequence for each block and generating frequency domain data of the image; and a data adjusting sequence of extracting only components of a limited frequency domain from the frequency domain data of the image generated in the discrete cosine transform sequence and generating compressed data.

According to the above-mentioned aspects, it is possible to provide an image compressing device, an image compressing method, and an image compressing program which can be easily stored in a small-scale hardware device (such as an FPGA or a digital circuit).

### BRIEF DESCRIPTION OF THE DRAWINGS

FIG. 1 is a block diagram illustrating the configuration of an image compressing device according to a first embodiment of the invention.

FIG. 2 is a diagram illustrating images of a process of extracting only components of a limited frequency domain, where Part (A) is a diagram illustrating a block obtained by dividing an input image into blocks consisting of 8 pixels×8 pixels and Part (B) is a diagram illustrating a frequency extraction block in a block obtained by transforming the divided block into the frequency domain through the discrete cosine transform.

FIG. 3 is a diagram illustrating images of a process performed by a data adjusting unit, where Part (A) is a diagram illustrating a block obtained by dividing an input image into blocks consisting of 8 pixels×8 pixels, Part (B) is a diagram illustrating a block obtained by transforming the divided block into the frequency domain through the discrete cosine transform, Part (C) is a diagram illustrating a block of which the frequency domain to be extracted is specified using a frequency extraction block in a block obtained by transforming the divided block into the frequency domain through the discrete cosine transform, and Part (D) is a diagram illustrating a block which was subjected to a predetermined dividing calculation in the block of which the frequency domain to be extracted is specified.

FIG. 4 is a block diagram illustrating the configuration of an image compressing device according to a second embodiment of the invention.

FIG. 5 is a diagram illustrating a comparison of a cutout of an image with resizing (reduction) of an image, where Part (A) is a diagram illustrating an example where an image is cut out and Part (B) is a diagram illustrating an example where an image is resized (reduced).

FIG. 6 is a flowchart illustrating an example of the schematic flow of processes performed by the image compressing device according to the second embodiment of the invention.

FIG. 7 is a flowchart illustrating an example of the schematic flow of processes performed when the resizing (reduction) of an image is performed instead of the cutout of an image.

FIG. 8 is a diagram illustrating examples of image quality of compressed images, where Part A is a diagram illustrating an example of an image before being compressed through the compressing process shown in FIG. 6, Part (B) is a diagram illustrating an example of an image which has been compressed through the compressing process shown in FIG. 6, Part (C) is a diagram illustrating an example of an image before being compressed through the compressing process shown in FIG. 7, and Part (D) is a diagram illustrating an example of an image which has been compressed through the compressing process shown in FIG. 7.

FIG. 9 is a block diagram illustrating the configuration of an image compressing device according to a third embodiment of the invention.

FIG. 10 is a diagram illustrating the schematic flow of processes performed in the image compressing device according to the third embodiment of the invention, where Part (A) is a diagram illustrating an example of an upper frame in an image, Part (B) is a diagram illustrating an example of an image of the upper frame which has been compressed, Part (C) is a diagram illustrating an example of a lower frame in the image, Part (D) is a diagram illustrating an example of an image of the lower frame which has been compressed, and Part (E) is a diagram illustrating an image obtained by combining the image of the upper frame and the image of the lower frame which has been compressed.

FIG. 11 is a block diagram illustrating the configuration of a JPEG encoder.

FIG. 12 is a diagram illustrating images of processes performed by the JPEG encoder, where Part (A) is a diagram illustrating a block obtained by dividing an input image into blocks consisting of 8 pixels×8 pixels, Part (B) is a diagram illustrating a frequency extraction block in a block obtained by transforming the divided block into the frequency domain through the discrete cosine transform, and Part (C) is a diagram illustrating a block having been subjected to division using a quantization table.

### DETAILED DESCRIPTION OF THE INVENTION

### First Embodiment

In this embodiment, an image compressing device 1 installed in an in-vehicle image processing device will be described as an example.

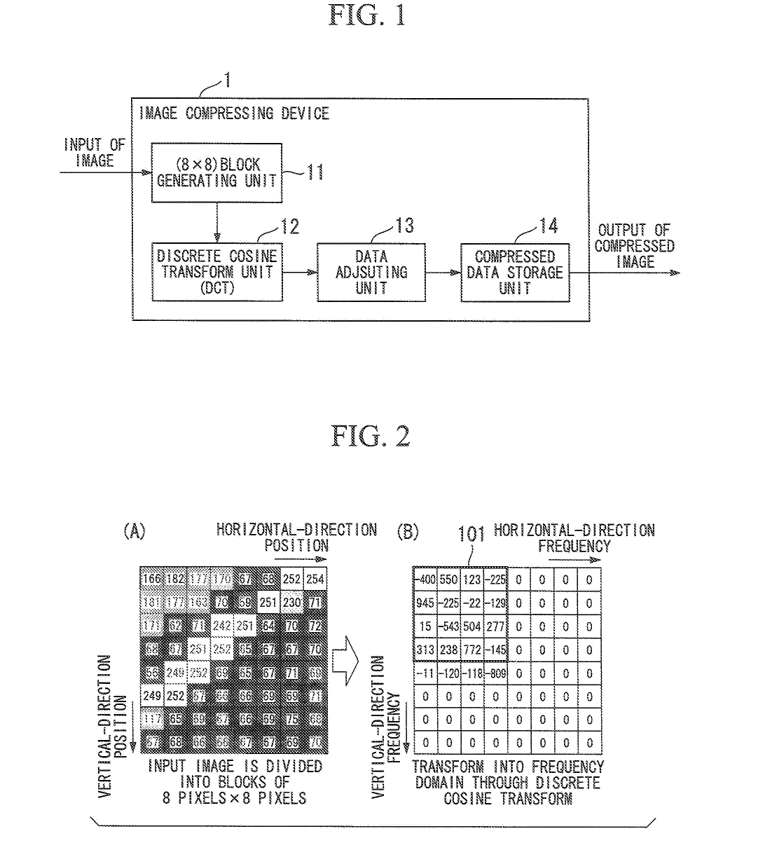

FIG. 1 is a block diagram illustrating the configuration of an image compressing device 1 according to a first embodiment of the invention.

The image compressing device 1 according to this embodiment includes a block generating unit 11, a discrete cosine transform unit 12, a data adjusting unit 13, and a compressed data storage unit 14.

The operations performed in the image compressing device 1 will be described below.

An image input to the image compressing device 1 is input to the block generating unit 11.

The block generating unit 11 divides the input image into blocks consisting of 8 pixels (horizontal direction (transverse direction))×8 pixels (vertical direction (longitudinal direction)) and outputs the resultant data corresponding to the plurality of blocks to the discrete cosine transform unit 12.

The discrete cosine transform unit 12 transforms an image from a spatial domain to a frequency domain by performing a discrete cosine transform (DCT) on the data corresponding to the plurality of blocks input from the block generating unit 11 for each block, and outputs the resultant frequency domain data of the image to the data adjusting unit 13.

The data adjusting unit 13 extracts only components of a limited frequency domain from the data of the frequency domain of the input image from the discrete cosine transform unit 12, applies a predetermined dividing calculation to the extracted components, and outputs the resultant compressed data to the compressed data storage unit 14.

Here, by extracting only the components of the limited frequency domain, for example, it is possible to round high-frequency components and to reduce the total amount of information.

By applying the predetermined dividing calculation, it is possible to perform the rounding. For example, a shifting calculation can be used as the predetermined dividing calculation.

The compressed data storage unit 14 stores compressed data input from the data adjusting unit 13 and outputs the compressed data. In this embodiment, the compressed data storage unit 14 includes a RAM (Random Access Memory) and stores only the components of a limited frequency domain in the RAM. The compression rate is (part of frequency domain to be extracted)/(all).

The compressed data output from the compressed data storage unit 14 is output as a compressed image from the image compressing device 1.

FIG. 2 is a diagram illustrating images of a process of extracting only the components of a limited frequency domain, where Part (A) is a diagram illustrating a block obtained by dividing an input image into blocks consisting of 8 pixels×8 pixels and Part (B) is a diagram illustrating a frequency extraction block 101 in the block obtained by transforming the divided block into the frequency domain through the discrete cosine transform.

The block shown in Part (A) of FIG. 2 is an example of the block generated by the block generating unit 11.

This block is in a spatial domain and includes 64 pixels in total, i.e., 8 pixels in the horizontal (transverse) direction and 8 pixels in the vertical (longitudinal) direction. Pixel values are marked in the cells of the pixels, respectively.

In this block, the coordinate value of a position in the horizontal direction increases as it goes to the right side, the coordinate value of a position in the vertical direction increases as it goes to the downside.

The block shown in Part (B) of FIG. 2 is an example of the block generated by the discrete cosine transform unit 12.

This block is in a frequency domain and includes 64 cells in total, i.e., 8 columns in the horizontal (transverse) direction and 8 rows in the vertical (longitudinal) direction. The values of frequency components corresponding to the cells are marked in the cells, respectively.

In this block, the frequency in the horizontal direction increases as it goes to the right side, the frequency in the vertical direction increases as it goes to the downside.

In the block shown in Part (B) of FIG. 2, the data adjusting unit 13 sets a predetermined frequency extraction block 101 including a smaller number of cells than the number of cells (64 cells in this embodiment) of the block. The data adjusting unit 13 extracts only the components of a limited frequency domain specified in the set frequency extraction block 101 from the block.

For example, like the frequency extraction block 101 shown in Part (B) of FIG. 2, when only the information of 4×4 cells among the 8×8 cells are left, it is possible to perform the compression so that the amount of data is 25% (=16/64). Here, the values in the frequency domain other than the inside of the frequency extraction block 101 are considered to be 0.

In this embodiment, the compressed data storage unit 14 stores only the information of the frequency domain (limited frequency domain) inside the frequency extraction block 101 in the memory (the RAM in this embodiment). In the example shown in Part (B) of FIG. 2, the compression rate is (number of cells of frequency domain to be extracted)/64.

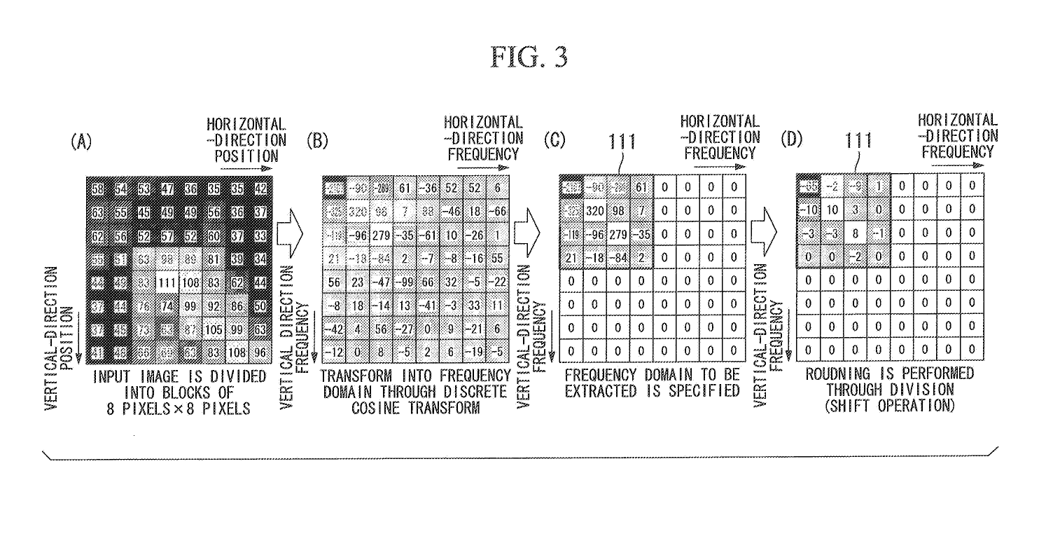

FIG. 3 is a diagram illustrating images of a process performed by the data adjusting unit 13, where Part (A) is a diagram illustrating a block obtained by dividing an input image into blocks consisting of 8 pixels×8 pixels, Part (B) is a diagram illustrating a block obtained by transforming the divided block into the frequency domain through the discrete cosine transform, Part (C) is a diagram illustrating a block of which the frequency domain to be extracted is specified using a frequency extraction block 111 in a block obtained by transforming the divided block into the frequency domain through the discrete cosine transform, and Part (D) is a diagram illustrating a block having been subjected to predetermined division in the block of which the frequency domain to be extracted is specified.

The block shown in Part (A) of FIG. 3 is an example of the block generated by the block generating unit 11.

This block is in a spatial domain and includes 64 pixels in total, i.e., 8 pixels in the horizontal (transverse) direction and 8 pixels in the vertical (longitudinal) direction. Pixel values are marked in the cells of the pixels, respectively.

In this block, the coordinate value of a position in the horizontal direction increases as it goes to the right side, the coordinate value of a position in the vertical direction increases as it goes to the downside.

The block shown in Part (B) of FIG. 3 is an example of the block generated by the discrete cosine transform unit 12.

This block is in a frequency domain and includes 64 cells in total, i.e., 8 columns in the horizontal (transverse) direction and 8 rows in the vertical (longitudinal) direction. The values of frequency components corresponding to the cells are marked in the cells, respectively.

In this block, the frequency in the horizontal direction increases as it goes to the right side, the frequency in the vertical direction increases as it goes to the downside.

The block shown in Part (C) of FIG. 3 is an example of the block in which only the components of the limited frequency domain specified inside the set frequency extraction block 111 are extracted from the block shown in Part (B) of FIG. 2 by the data adjusting unit 13.

The values of the cells inside the frequency extraction block 111 are not changed and the values of the other cells (the cells outside the frequency extraction block 111) are all set to 0.

The block shown in Part (D) of FIG. 3 is an example of the block which is rounded by causing the data adjusting unit to perform predetermined division (the predetermined shift operation in this embodiment) on the block shown in Part (C) of FIG. 3.

In this example, the values are shifted to increase by 5 bits (=32) when obtaining the values of the frequency domain in the block shown in Part (B) of FIG. 3, and the values are reversely shifted to decrease by 5 bits (=32) when obtaining the values of the frequency domain in the block shown in Part (D) of FIG. 3.

In this embodiment, the case where a block consisting of 8 pixels×8 pixels is generated in the spatial domain by the block generating unit 11 is described, but a configuration for generating a block of another size may be employed.

Specifically, a configuration in which a block of N pixels (horizontal direction)×M pixels (vertical direction) is generated in the spatial domain by the block generating unit 11 may be employed, where N and M are integers of 1 or greater, respectively, and at least one of N and M is greater than or equal to 2. N and M may be equal to or different from each other.

When the block of N pixels (horizontal direction)×M pixels (vertical direction) in the spatial domain is subjected to the discrete cosine transform, a block of N columns (horizontal direction)×M rows (vertical direction) in the frequency domain is generated.

The discrete cosine transform is not limited to a square (N×M: N=M) in expressions, but can be calculated with any rectangle (M×N: N#M).

As the area of the frequency extraction block (the frequency extraction block 101 shown in Part (B) of FIG. 2 or the frequency extraction block 111 shown in Part (C) of FIG. 3) used in the data adjusting unit 13, an area of any shape may be used. For example, an area of a shape approximately including an area in which the horizontal-direction frequency or the vertical-direction frequency is low and excluding an area in which the horizontal-direction frequency or the vertical-direction frequency is high is used. However, it may necessarily not be established that the overall area included in the frequency extraction block is lower in frequency than the overall area excluded from the frequency extraction block.

The area of the frequency extraction block used in the data adjusting unit 13 corresponds to the area in which information is stored in the compressed data storage unit 14.

In an example, the area of the frequency extraction block (the frequency extraction block 101 shown in Part (B) of FIG. 2 or the frequency extraction block 111 shown in Part (C) of FIG. 3) used in the data adjusting unit 13 may be determined in advance and may be stored in the memory of the data adjusting unit 13 or the like. In another example, a configuration in which the operation of a user (person) on a predetermined operation unit is received and the area of the frequency extraction block is set or switched depending on the details of the received operation may be used.

In this embodiment, the data adjusting unit 13 performs a process of extracting only components of a limited frequency domain from the data of the frequency domain of the image input from the discrete cosine transform unit 12 and then applying a predetermined dividing calculation to the extracted components. However, in another example, the data adjusting unit 13 may first apply the predetermined dividing calculation to the frequency domain data of the image input from the discrete cosine transform unit 12 and then may perform the process of extracting only components of a limited frequency domain.

In this manner, the image compressing device 1 according to this embodiment can be easily stored in hardware such as a small-scale hardware device (such as an FPGA or a digital circuit).

In the image compressing device 1 according to this embodiment, for example, in comparison with the JPEG the processes of the quantization unit and the entropy encoding unit (Huffman encoding or the like) in the JPEG are not used, but the frequency domain of the calculation result of the discrete cosine transform (DCT) is specified. In the image compressing device 1 according to this embodiment, it is possible to achieve the decrease in computational load and the reduction in scale of the overall circuit by performing the process of specifying the frequency domain of the calculation result of the discrete cosine transform (DCT) and deleting the entropy encoding process in the JPEG file. In the image compressing device 1 according to this embodiment, since the entropy encoding process is not used, the data size after being compressed is fixed and thus the storage of data can be facilitated, thereby improving the mounting facilitation.

Here, the JPEG is characterized in that a high-frequency domain in which an error is hardly recognized with a human eye is rounded. As the amount of continuous data in high-frequency components increases, it is possible to reduce the amount of information through the entropy encoding.

However, for example, when low image quality of an image after being compressed is acceptable, it is possible to reduce the amount of information without performing the entropy encoding, by limiting the frequency domain (for example, the frequency domain stored in the memory after being quantized) stored in the memory. In this case, by limiting the frequency domain, the information of the high-frequency domain is rounded off. In such a configuration, since the entropy encoding is not performed, the data size of the compressed image can be fixed and thus the compressed image can be easily stored in the memory. Accordingly, it is possible to improve the hardware mounting facilitation and to make quantization unnecessary.

The configuration in which an image is compressed by the image compressing device 1 according to this embodiment can be applied to an in-vehicle image processing device requiring such accuracy that situations such as roads, buildings, or other vehicles have only to be recognized to a certain extent from the image which has been compressed. Here, an image captured with a camera mounted on the front side of a vehicle or the like can be input to the image compressing device 1 and can be compressed therein, and various image processes can be performed using the compressed image by the image processing device. In this case, for example, even when the image quality of an image is fairly low, it is possible to reduce the resources or capacity of the apparatus. The image compressing device 1 may be included as a part of the image processing device or may be provided as a device separate from the image processing device.

### Second Embodiment

In this embodiment, an image compressing device 2 installed in an in-vehicle image processing device will be described as an example.

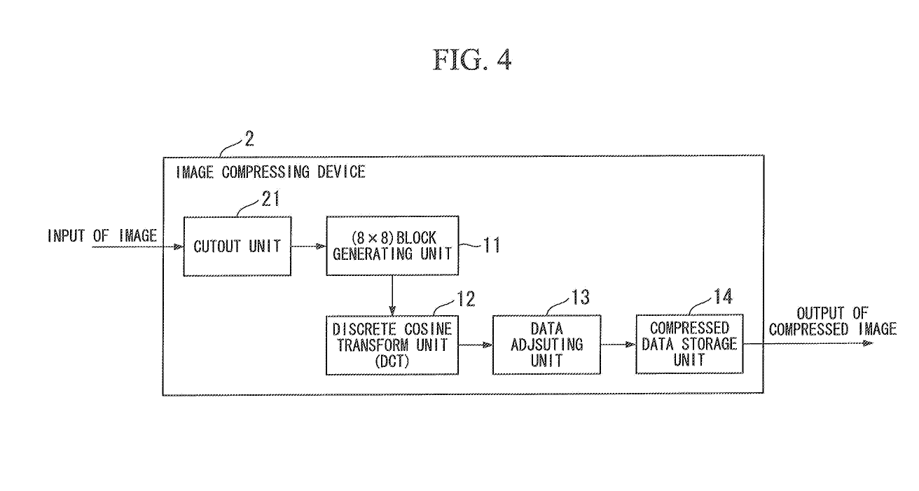

FIG. 4 is a block diagram illustrating the configuration of an image compressing device 2 according to a second embodiment of the invention.

The image compressing device 2 according to this embodiment includes a cutout unit 21, a block generating unit 11, a discrete cosine transform unit 12, a data adjusting unit 13, and a compressed data storage unit 14.

Here, the image compressing device 2 according to this embodiment approximately has a configuration in which the cutout unit 21 is disposed on the input side of the block generating unit 11 in the image compressing device 1 according to the first embodiment shown in FIG. 1. Accordingly, in FIG. 4, the same units as shown in FIG. 1 are referenced by the same reference numerals, parts different from those of the first embodiment will be described in detail in this embodiment, and parts the same as those of the first embodiment will not be described again or will be described in brief.

The operations performed in the image compressing device 2 will be described below.

An image input to the image compressing device 2 is input to the cutout unit 21.

The cutout unit 21 cuts out a predetermined part of the input image and outputs the cut-out image to the block generating unit 11

The block generating unit 11 divides the image input from the cutout unit 21 into blocks consisting of 8 pixels×8 pixels and outputs the resultant data of the generated blocks to the discrete cosine transform unit 12.

The block generating unit 11 and the discrete cosine transform unit 12, the data adjusting unit 13, and the compressed data storage unit 14 subsequent thereto perform the same processes as those of the first embodiment shown in FIG. 1.

Here, the positional relationship of a predetermined image part with respect to an original image when the predetermined image part is cut out from the original image by the cutout unit 21 may be determined in advance and may be stored in the memory of the cutout unit 21 or the like in an example. In another example, a configuration in which an operation of a user (person) on a predetermined operation unit is received and the positional relationship of the predetermined image part with respect to the original image is set or switched depending on the details of the received operation may be used.

The cutout of an image and the resizing of an image will be described below.

Here, as a resizing process of changing the size of an image, a process of reducing an overall original image because the size of the original image is excessively large is considered. Specific examples of the resizing process include a process of reducing the size of the image to a quarter by thinning out pixels of the original image by the quarter or the like and a process of reducing the size of the image to a quarter by averaging every four pixels in the original image so as to form a pixel.

For example, in the configuration in which an image is resized (reduced) before compressing the image through the use of the image compressing device 1 shown in FIG. 1, the resizing (reducing) of the image may be performed before the image is input to the image compressing device 1, or the resizing (reducing) may be performed instead of cutting out through the use of the image in the cutout unit 21 shown in FIG. 4. However, in the configuration in which the resizing (reducing) of an image is performed, an image of a block consisting of 8 pixels×8 pixels becomes complicated and the importance of high-frequency components in the image of a block consisting of 8 pixels×8 pixels is raised, compared with a case where the resizing (reducing) of an image is not performed. This phenomenon becomes more marked when the size of the original image is small.

However, like this embodiment, in the configuration in which an image is compressed by limiting a frequency domain so as to cut off information of a high-frequency domain, it is preferable that the importance of high-frequency components in the image of a block consisting of 8 pixels×8 pixels be low.

Accordingly, in the image compressing device 2 according to this embodiment shown in FIG. 4, the resizing (reducing) is not performed on an input image and the size of the input image is maintained without any reduction in comparison with the case where such a resizing (reducing) is performed, whereby the importance of high-frequency components in the image of a block consisting of 8 pixels×8 pixels is lowered. In the image compressing device 2 according to this embodiment, a predetermined part of an input image is cut out by the cutout unit 21 and the subsequent compressing process is performed on the cut-out image part. Accordingly, compared with the configuration in which the resizing (reducing) of an image is performed, the image of a block consisting of 8 pixels×8 pixels has a simple pattern and the importance of high-frequency components in the image of a block consisting of 8 pixels×8 pixels is lowered, whereby it is possible to reproduce an image with only a small amount of information of low-frequency components.

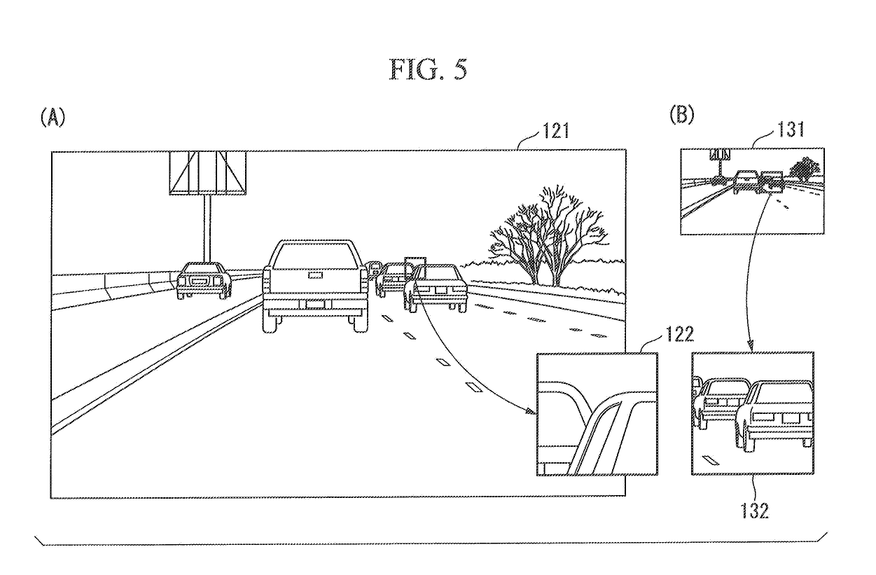

FIG. 5 is a diagram illustrating comparison of the cutout of an image and the resizing (reducing) of an image with each other, where Part (A) is a diagram illustrating an example where the cutout of an image is performed and Part (B) is a diagram illustrating an example where the resizing (reducing) of an image is performed.

Part (A) of FIG. 5 shows an example of an image 121 not subjected to the resizing (reducing). When the importance of high-frequency components in the image of a block consisting of 8 pixels×8 pixels is considered and the cutout of an image is performed, this is the same as compressing the image 121 shown in Part (A) of FIG. 5.

Part (B) of FIG. 5 shows an example of an image 131 obtained by resizing (reducing) of the image 121 shown in Part (A) of FIG. 5.

Here, the image of a block 122 consisting of 8 pixels×8 pixels in the image 121 shown in Part (A) of FIG. 5 can be considered as the image size thereof being substantially enlarged in comparison with the image of a block 132 consisting of 8 pixels×8 pixels of the resized (reduced) image 131 shown in Part (B) of FIG. 5 and is an image having a non-complicated and simple pattern.

In this example, the image of the block 122 consisting of 8 pixels×8 pixels in the image 121 shown in Part (A) of FIG. 5 includes only a part of an image of vehicles and thus the pattern thereof is more simplified.

On the other hand, the image of the block 132 consisting of 8 pixels×8 pixels in the resized (reduced) image 131 shown in Part (B) of FIG. 5 includes most of the image of vehicles and the pattern thereof is more complicated.

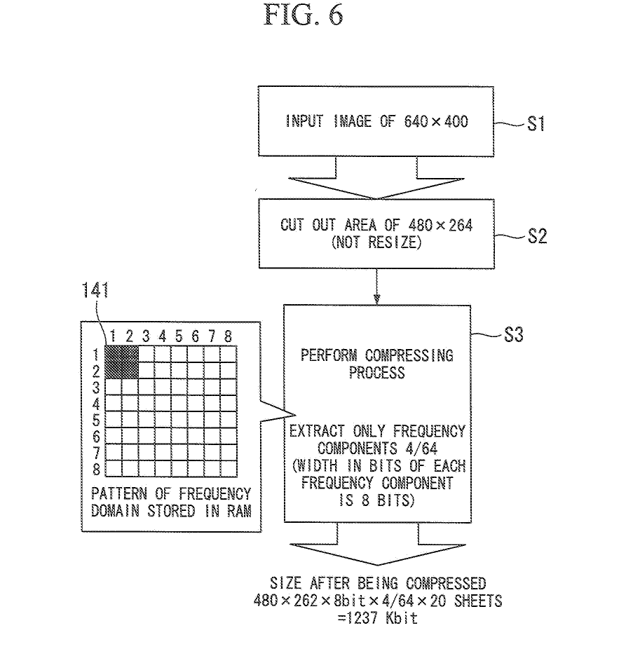

FIG. 6 is a flowchart illustrating an example of the schematic flow of processes performed by the image compressing device 2 according to the second embodiment of the invention. Values shown in this example are only exemplary values and the invention is not limited to these exemplary values.

In this example, an image having a size of 640 pixels (horizontal direction)×400 pixels (vertical direction) is input to the image compressing device 2 (step S1).

The cutout unit 21 cuts out an image having a size of 480 pixels (horizontal direction)×264 pixels (vertical direction) as a predetermined image part from the image input to the image compressing device 2 (step S2) and outputs the cut-out image to the block generating unit 11. In this embodiment, the central positions of the input image (the original image) and the image cut out therefrom are set to the same position (or the closest position when the same position is not possible).

The block generating unit 11, the discrete cosine transform unit 12, and the data adjusting unit 13 perform the compressing process on the image input from the cutout unit 21 to the block generating unit 11, and outputs data of the image (compressed data) which has been compressed to the compressed data storage unit 14 (step S3).

In this compressing process, the input image and the output image have a size of 480 pixels (horizontal direction)×264 pixels (vertical direction). The size of the input image is in the units of pixels and the size of the output image is in the units of cells in the frequency domain.

In this embodiment, the width in bits (the width in bits of each frequency component) of one cell in the frequency domain is 8 bits.

Here, in the example shown in FIG. 6, a frequency extraction block 141 for extracting only the frequency components of 4/64 is used as shown in FIG. 6 and the pattern of the extracted frequency components is the pattern of the frequency domain stored in the compressed data storage unit 14 (a RAM in this embodiment).

The frequency extraction block 141 shown in FIG. 6 extracts only components of four frequency domains (cells) of which (horizontal-direction position, vertical-direction position) is (1, 1), (2, 1), (1, 2), and (2, 2) among 8 columns (horizontal-direction frequency)×8 rows (vertical-direction frequency).

In the example shown in FIG. 6, the image size of 20 sheets of images which have been compressed is as follows.

Image size after being compressed (20 sheets)=480×264×8 bit×4/64×20=1237 Kbit

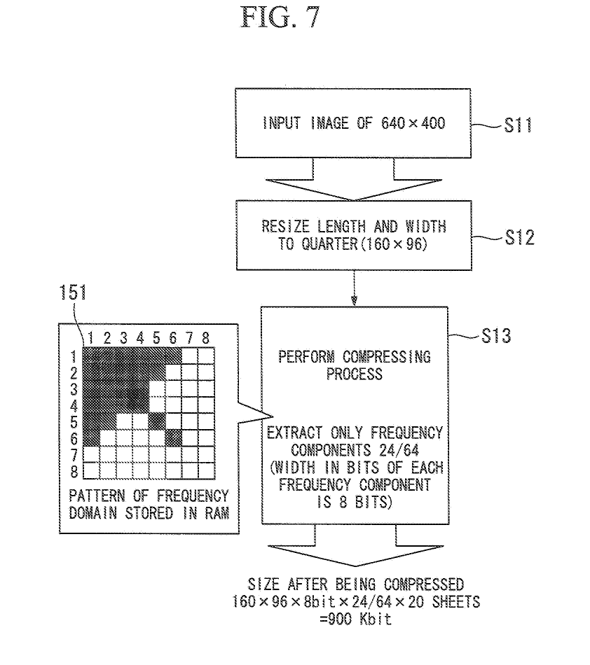

FIG. 7 is a flowchart illustrating an example of the schematic flow of processes performed when the resizing (reducing) of an image is performed instead of the cutout of an image. Values shown in this example are only exemplary values and the invention is not limited to these exemplary values.

In this example, an image having a size of 640 pixels (horizontal direction)×400 pixels (vertical direction) is input to an image compressing device (step S11). In this example, the image compressing device including a resizing unit resizing an image is used.

The resizing unit resizes the image input to the image compressing device (step S12). In the resizing of this example, the length and the width of the image are reduced to a quarter and about a quarter to obtain an image having a size of 160 pixels (horizontal direction)×96 pixels (vertical direction). In this example, the central positions of the input image (the original image) and the image cut out therefrom are set to the same position (or the closest position when the same position is not possible).

Then, a compressing process is performed on the resized image (step S13). In this example, this compressing process is performed by the same processing units as the block generating unit 11, the discrete cosine transform unit 12, and the data adjusting unit 13 shown in FIG. 4.

In this compressing process, the input image and the output image have a size of 160 pixels (horizontal direction)×96 pixels (vertical direction). The size of the input image is in the units of pixels and the size of the output image is in the units of cells in the frequency domain.

In this example, the width in bits (the width in bits of each frequency component) of one cell in the frequency domain is 8 bits.

Here, in the example shown in FIG. 7, a frequency extraction block 151 for extracting only the frequency components of 24/64 is used as shown in FIG. 7 and the pattern of the extracted frequency components is the pattern of the frequency domain stored in the same processing unit (a RAM in this example) as the compressed data storage unit 14 shown in FIG. 4.

The frequency extraction block 151 shown in FIG. 7 extracts only components of 24 frequency domains (cells) in total including components of 16 frequency domains (cells) of which the position in the horizontal direction is in the range of 1 to 4 and the position in the vertical direction is in the range of 1 to 4 and components of 8 frequency domains (cells) of which (horizontal-direction position, vertical-direction position) is (5, 1), (6, 1), (5, 2), (1, 5), (1, 6), (2, 5), (5, 5), and (6, 6) among 8 columns (horizontal-direction frequency)×8 rows (vertical-direction frequency).

In the example shown in FIG. 7, the image size of 20 sheets of images which have been compressed is as follows.

Image size after being compressed (20 sheets)=160×96×8 bit×24/64×20=900 Kbit

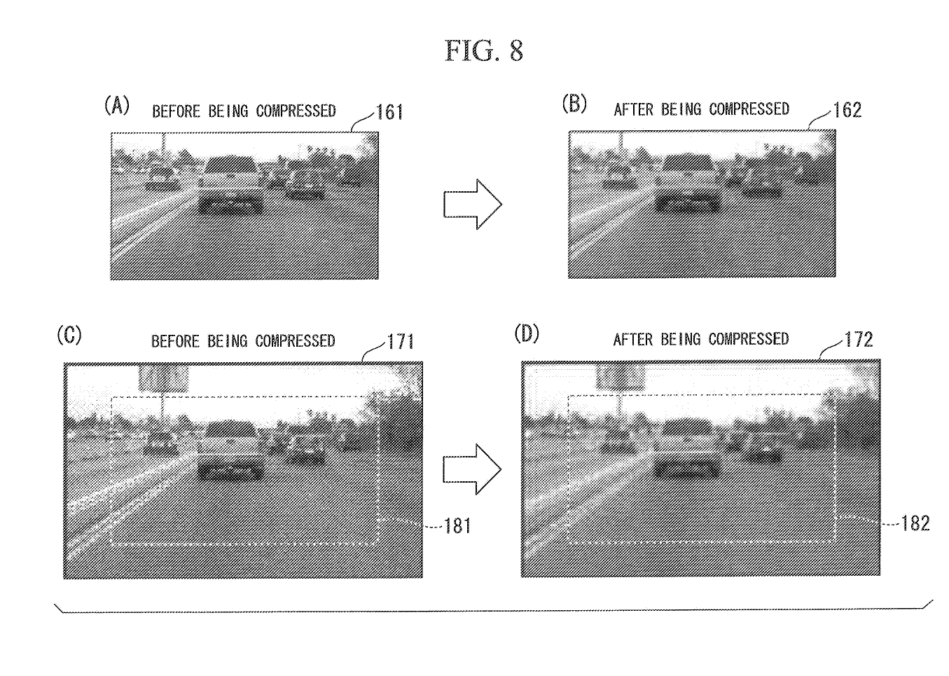

FIG. 8 is a diagram illustrating examples of image quality of compressed images, where Part (A) is a diagram illustrating an example of an image 161 before being compressed through the compressing process shown in FIG. 6, Part (B) is a diagram illustrating an example of an image 162 which has been compressed through the compressing process shown in FIG. 6, Part (C) is a diagram illustrating an example of an image 171 before being compressed through the compressing process shown in FIG. 7, and Part (D) is a diagram illustrating an example of an image 172 which has been compressed through the compressing process shown in FIG. 7.

As described above, the image compressing device 2 according to this embodiment cuts out an image. Accordingly, for example, compared with the configuration in which the resizing (reducing) of an image is performed, the image of a block consisting of 8 pixels×8 pixels has a simple pattern and the importance of high-frequency components in the image of a block consisting of 8 pixels×8 pixels is lowered, whereby it is possible to reproduce an image with only a small amount of information of low-frequency components.

Similarly to the first embodiment, the image compressing device 2 according to this embodiment can be easily stored in hardware such as a small-scale hardware device (such as an FPGA or a digital circuit).

### Third Embodiment

In this embodiment, an image compressing device 3 installed in an in-vehicle image processing device will be described as an example.

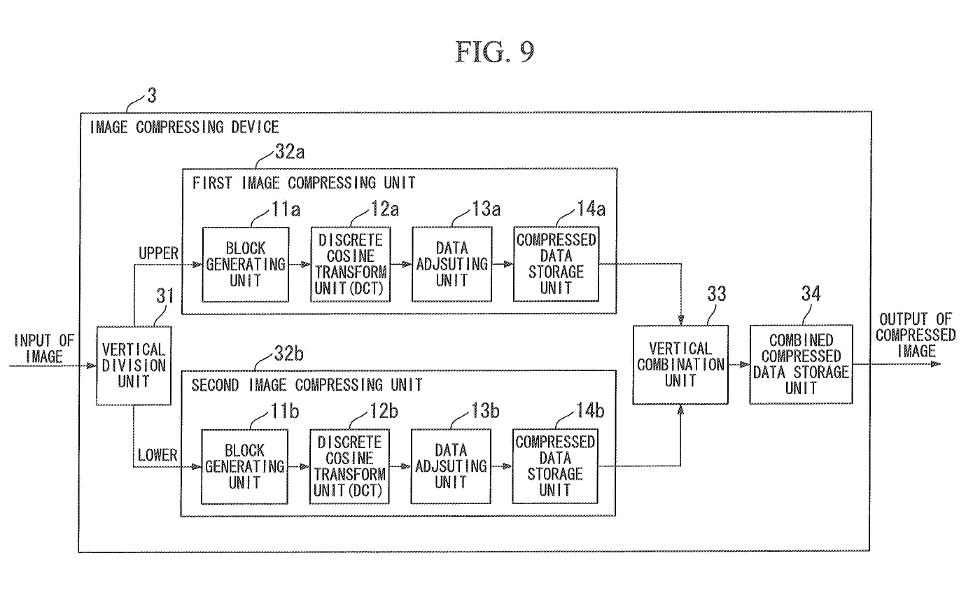

FIG. 9 is a block diagram illustrating the configuration of an image compressing device 3 according to a third embodiment of the invention.

The image compressing device 3 according to this embodiment includes a vertical division unit 31, a first image compressing unit 32a, a second image compressing unit 32b, a vertical combination unit 33, and a combined compressed data storage unit 34.

The first image compressing unit 32a includes a block generating unit 11a, a discrete cosine transform unit 12a, a data adjusting unit 13a, and a compressed data storage unit 14a.

The second image compressing unit 32b includes a block generating unit 11b, a discrete cosine transform unit 12b, a data adjusting unit 13b, and a compressed data storage unit 14b.

The operations performed in the image compressing device 3 will be described below.

An image input to the image compressing device 3 is input to the vertical division unit 31.

The vertical division unit 31 divides the input image into an upper part and a lower part in the vertical direction, outputs the divided upper part image to the first image compressing unit 32a, and outputs the divided lower part image to the second image compressing unit 32b.

The first image compressing unit 32a performs a compressing process on the upper part image input from the vertical division unit 31 using a first frequency extraction block through the same operations as in the image compressing device 1 according to the first embodiment shown in FIG. 1, and outputs the data which have been compressed (compressed data) to the vertical combination unit 33.

Here, the block generating unit 11a, the discrete cosine transform unit 12a, the data adjusting unit 13a, and the compressed data storage unit 14a included in the first image compressing unit 32a perform the same operations as those included in the image compressing device 1 according to the first embodiment shown in FIG. 1.

The second image compressing unit 32b performs a compressing process on the lower part image input from the vertical division unit 31 using a second frequency extraction block through the same operations as in the image compressing device 1 according to the first embodiment shown in FIG. 1, and outputs the data which have been compressed (compressed data) to the vertical combination unit 33.

Here, the block generating unit 11b, the discrete cosine transform unit 12b, the data adjusting unit 13b, and the compressed data storage unit 14b included in the second image compressing unit 32b perform the same operations as those included in the image compressing device 1 according to the first embodiment shown in FIG. 1.

The vertical combination unit 33 combines the compressed data of the upper part image input from the first image compressing unit 32a and the compressed data of the lower part image input from the second image compressing unit 32b and outputs the combined compressed data to the combined compressed data storage unit 34.

The combined compressed data storage unit 34 stores the combined compressed data input from the vertical combination unit 33 and outputs the combined compressed data. In this embodiment, the combined compressed data storage unit 34 includes a RAM, and stores the combination result of components of limited frequency domains of the upper part and the lower part of the original image in the RAM. The compression rate is (parts of frequency domains to be extracted from upper part and lower part)/(all).

The compressed data output from the combined compressed data storage unit 34 is output as a compressed image from the image compressing device 3.

Here, in this embodiment, by changing the frequency components to be extracted from the image area of the upper part and the image area of the lower part depending on the image areas, the image quality of the images which have been compressed is changed.

In this embodiment, for example, an image captured with a camera mounted on the front side of a vehicle or the like is compressed by the use of the image compressing device 3. Accordingly, in the image to be compressed, the upper part of the image is a long-distance view, other vehicles or structures are shown to be small, and the high-frequency components become more important. On the contrary, the lower part of the image is a short-distance view, other vehicles or structures are shown to be large, and the low-frequency components become more important.

Therefore, in this embodiment, the first frequency extraction block used in the data adjusting unit 13a of the first image compressing unit 32a is set to a pattern capable of extracting the higher-frequency components to correspond to the features of the image area of the upper part. The second frequency extraction block used in the data adjusting unit 13b of the second image compressing unit 32b is set to a pattern capable of extracting the lower-frequency components to correspond to the features of the image area of the lower part.

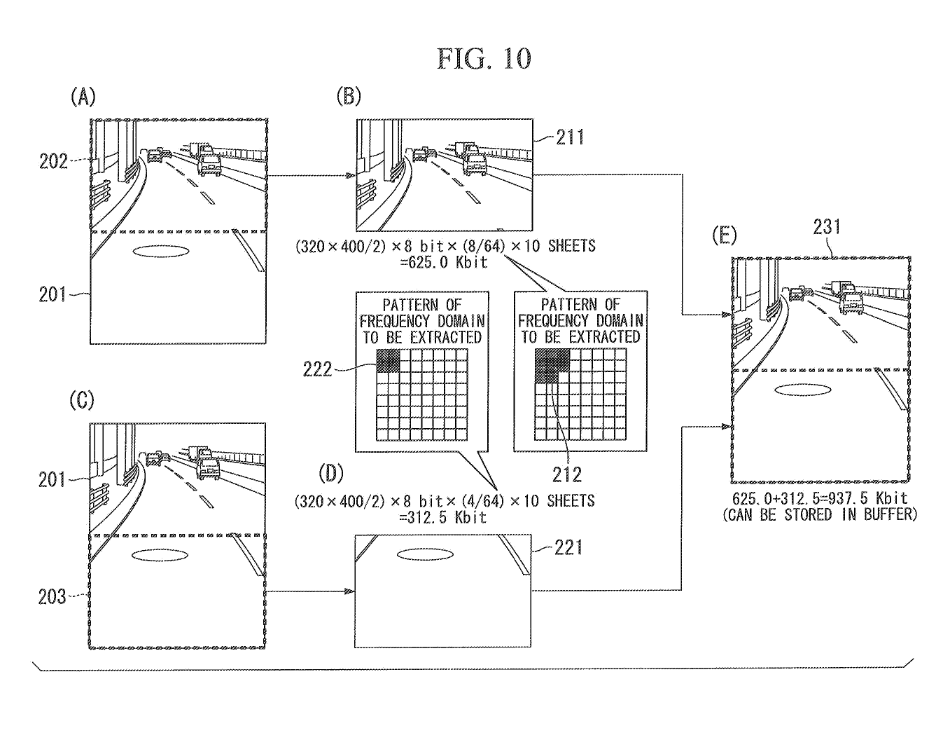

FIG. 10 is a diagram illustrating the schematic flow of processes performed in the image compressing device 3 according to the third embodiment of the invention, where Part (A) is a diagram illustrating an example of an upper frame 202 in an image 201, Part (B) is a diagram illustrating an example of the image 211 of the upper frame after being compressed, Part (C) is a diagram illustrating an example of a lower frame 203 in the image 201, Part (D) is a diagram illustrating an example of an image 221 of the lower frame which has been compressed, and Part (E) is a diagram illustrating an image 231 obtained by combining the image 211 of the upper frame and the image 221 of the lower frame which has been compressed.

In this example, an image 201 having a size of 320 pixels (horizontal direction)×400 pixels (vertical direction) is input to the image compressing device 3.

In this example, the width in bits (the width in bits of each frequency component) of one cell in the frequency domain is 8 bits.

Part (A) of FIG. 10 shows an upper frame 202 set in the image 201 input to the image compressing device 3. The upper frame 202 is set by the vertical division unit 31. The vertical division unit 31 divides the image part of the upper frame 202 as the upper part image.

Part (C) of FIG. 10 shows a lower frame 203 set in the image 201 input to the image compressing device 3. The lower frame 203 is set by the vertical division unit 31. The vertical division unit 31 divides the image part of the lower frame 203 as the lower part image.

In this embodiment, the upper frame 202 and the lower frame 203 set in the image 201 divide the image 202 into the half. That is, the upper frame 202 extracts the image part from the uppermost part to the half in the vertical direction of the image 201 and the lower frame 203 extracts the image part from the half to the lowermost part in the vertical direction of the image 201.

Part (B) of FIG. 10 shows an image 211 by extracting only the frequency components included in a predetermined frequency extraction block (the first frequency extraction block) 212 from the upper part image (the upper half image) of the image 201 through the use of the data adjusting unit 13a of the first image compressing unit 32a and compressing the extracted frequency components.

The frequency extraction block 212 for the upper part image 211 used in this example extracts only components of 8 frequency domains (cells) in total including components of 4 frequency domains (cells) of which the position in the horizontal direction is in the range of 1 to 2 and the position in the vertical direction is in the range of 1 to 2 and components of 4 frequency domains (cells) of which (horizontal-direction position, vertical-direction position) is (3, 1), (3, 2), (1, 3), and (2, 3) among 8 columns (horizontal-direction frequency)×8 rows (vertical-direction frequency).

Here, the compressed upper part image 211 has a size of 320 (horizontal direction)×400/2 (vertical direction).

In this example, the size of the upper part image 211 after being compressed is as follows for 10 sheets of images.

Size of upper part image 211 which has been compressed (10 sheets)=(320×400/2)×8 bit×8/64×10=625.0 Kbit

Part (D) of FIG. 10 shows an image 221 by extracting only the frequency components included in a predetermined frequency extraction block (the second frequency extraction block) 222 from the lower part image (the lower half image) of the image 201 through the use of the data adjusting unit 13b of the second image compressing unit 32b and compressing the extracted frequency components.

The frequency extraction block 222 for the lower part image 221 used in this example extracts only components of 4 frequency domains (cells) of which the position in the horizontal direction is in the range of 1 to 2 and the position in the vertical direction is in the range of 1 to 2 among 8 columns (horizontal-direction frequency)×8 rows (vertical-direction frequency).

Here, the compressed lower part image 221 has a size of 320 (horizontal direction)×400/2 (vertical direction).

In this example, the size of the lower part image 221 which has been compressed is as follows for 10 sheets of images.

Size of lower part image 221 which has been compressed (10 sheets)=(320×400/2)×8 bit×4/64×10=312.5 Kbit

Part (E) of FIG. 10 shows an image (overall image) 231 obtained by combining the compressed upper part image 211 and the compressed lower part image 221.

In this example, the size of the overall image 231 which has been compressed is as follows for 10 sheets of images.

Size of overall image 231 which has been compressed (10 sheets)=625.0+312.5=937.5 Kbit

In the overall image 231 after being combined, in comparison of the upper part image 211 and the lower part image 221 with each other, the size of data of the upper part image 211 becomes larger and the size of data of the lower part image 221 becomes smaller.

For example, when a compressing process is performed on the overall original image 201 using the same frequency extraction block 212 as for the upper part image 211, the size (10 sheets) of the overall image which has been compressed is 1250.0 (=625.0×2) Kbit. However, in this embodiment, the size (10 sheets) of the overall image 231 which has been compressed is 937.5 Kbit. Accordingly, when this embodiment is not employed, the data of the overall image which has been compressed may exceed the capacity of a buffer and the data of the image may not be stored in the buffer, depending on the capacity of the buffer to be used. On the contrary, when this embodiment is employed, the data of the overall image 231 which has been compressed may be less than or equal to the capacity of the buffer and the data of the image 231 may be stored in the buffer.

As described above, in the image compressing device 3 according to this embodiment, an image is divided into upper and lower parts, the frequency domain to be extracted is set to be large for the upper area (long-distance view) of the image in which the high-frequency components become more important, and the frequency domain to be extracted is set to be small for the lower area (short-distance view) of the image in which the high-frequency components are not as important as in the long-distance view. In the image compressing device 3 according to this embodiment, by changing the frequency domain to be extracted depending on the image areas in this manner, it is possible to reduce the data size of an image which has been compressed while the image quality of the image maintained.

Similarly to the first embodiment, the image compressing device 3 according to this embodiment can be easily stored in hardware such as a small-scale hardware device (such as an FPGA or a digital circuit).

In this embodiment, an image to be compressed is divided into an upper half part and a lower half part. In an example, the image to be compressed may be divided into an upper part and a lower part at a ratio of n to m, where n and m are arbitrary values (n and m may be different from each other).

In this manner, the ratio (n to m) for dividing an image to be compressed into an upper part and a lower part may be determined in advance and may be stored in the memory of the vertical division unit 31 or the like in an example. In another example, a configuration in which an operation of a user (person) on a predetermined operation unit is received and the ratio is set or switched depending on the details of the received operation may be used.

The area of the first frequency extraction block used in the data adjusting unit 13a of the first image compressing unit 32a or the area of the second frequency extraction block used in the data adjusting unit 13b of the second image compressing unit 32b may be determined in advance and may be stored in the memory of the data adjusting units 13a and 13b or the like in an example. In another example, a configuration in which an operation of a user (person) on a predetermined operation unit is received and the area of the first frequency extraction block or the area of the second frequency extraction block is set or switched depending on the details of the received operation may be used.

For example, the same processing unit as the cutout unit 21 included in the image compressing unit 2 according to the second embodiment shown in FIG. 4 may be disposed at the front stage of the vertical division unit 31 included in the image compressing device 3 according to this embodiment shown in FIG. 9. In this configuration, the same advantages as in the second embodiment can be achieved.

In this embodiment, the compressed data storage units 14a and 14b are disposed in the first image compressing unit 32a or the second image compressing unit 32b in the image compressing device 3 shown in FIG. 9. In another example, a configuration in which the compressed data storage units 14a and 14b are not disposed in the first image compressing unit 32a or the second image compressing unit 32b may be used.

### Summary of JPEG Algorithm

The summary of a JPEG algorithm will be described below as an example of a technique relevant to an image compressing process.

In the JPEG (Joint Photographic Experts Group), an image is divided into blocks consisting of 8 pixels×8 pixels and a compressing process is performed for each block.

The image compressing process of the JPEG is broadly classified into three processes of a discrete cosine transform (DCT) process, a quantization process, and an entropy encoding process.

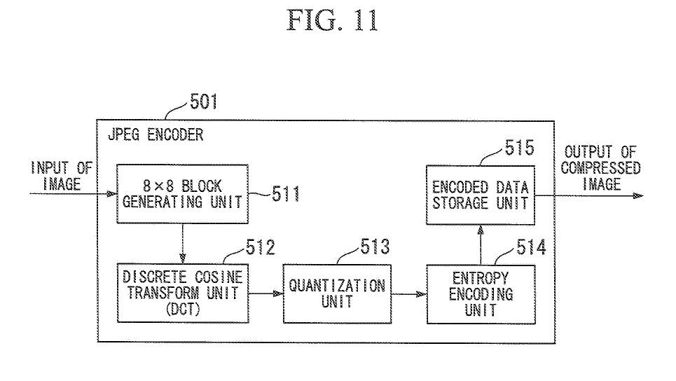

FIG. 11 is a block diagram illustrating the configuration of a JPEG encoder 501.

The JPEG encoder 501 includes an 8×8 block generating unit 511, a discrete cosine transform unit 512, a quantization unit 513, an entropy encoding unit 514, and an encoded data storage unit 515.

The operations performed in the JPEG encoder 501 will be described below.

An image input to the JPEG encoder 501 is input to the 8×8 block generating unit 511.

The 8×8 block generating unit 511 divides the input image into blocks consisting of 8 pixels×8 pixels and outputs the resultant data of the divided blocks to the discrete cosine transform unit 512.

The discrete cosine transform unit 512 transforms an image from a spatial domain to a frequency domain by performing a discrete cosine transform (DCT) on the data of the blocks input from the 8×8 block generating unit 511 for each block, and outputs the resultant frequency domain data of the image to the quantization unit 513. The frequency domain data of the image express an image as an overlap of waves of frequency components.

The quantization unit 513 quantizes the frequency domain data of the image input from the discrete cosine transform unit 512 using a quantization table, and outputs the quantized data to the entropy encoding unit 514. The quantization can round high-frequency components using the characteristic that a human eye hardly recognizes the error of the high-frequency components and can reduce the total amount of information.

The entropy encoding unit 514 performs the entropy encoding process using Huffman codes on the quantized data input from the quantization unit 513, and outputs the resultant encoded data to the encoded data storage unit 515. The entropy encoding process is a process of searching for continuous data (particularly, data in which 0 is continuous in the JPEG) and reducing the overall code length. As the more amount of continuous data is present in the quantization result, the compression rate increases.

The encoded data storage unit 515 stores the encoded data input from the entropy encoding unit 514 and outputs the encoded data.

The encoded data output from the encoded data storage unit 515 is output as a compressed image from the JPEG encoder 501.

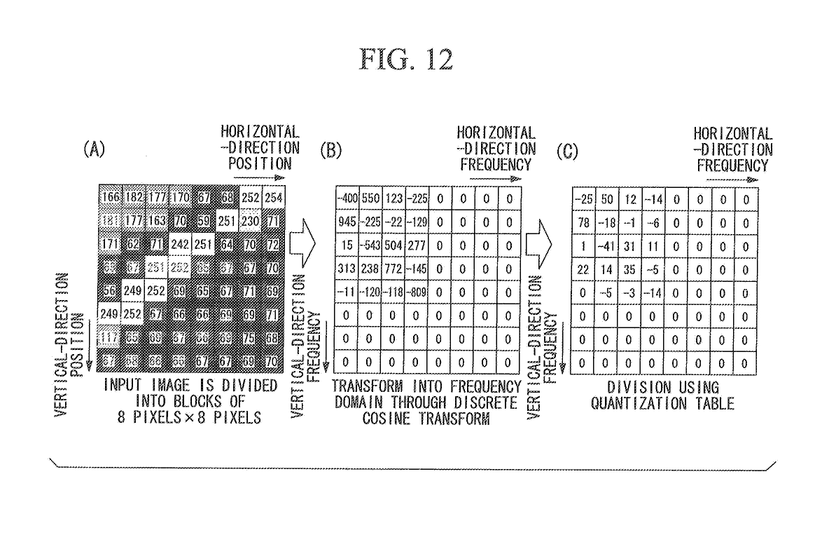

FIG. 12 is a diagram illustrating images of a process performed by the JPEG encoder 501, where Part (A) is a diagram illustrating a block obtained by dividing an input image into blocks consisting of 8 pixels×8 pixels, Part (B) is a diagram illustrating a block obtained by transforming the divided block into the frequency domain through the discrete cosine transform, and Part (C) is a diagram illustrating a block subjected to a division process using a quantization table.

The block shown in Part (A) of FIG. 12 is an example of the block generated by the 8×8 block generating unit 511.

This block is in a spatial domain and includes 64 pixels in total, i.e., 8 pixels in the horizontal (transverse) direction and 8 pixels in the vertical (longitudinal) direction. Pixel values are marked in cells of the pixels, respectively.

In this block, the coordinate value of a position in the horizontal direction increases as it goes to the right side, the coordinate value of a position in the vertical direction increases as it goes to the downside.

The block shown in Part (B) of FIG. 12 is an example of the block generated by the discrete cosine transform unit 512.

This block is in a frequency domain and includes 64 cells in total of 8 columns in the horizontal (transverse) direction and 8 rows in the vertical (longitudinal) direction. The values of frequency components corresponding to the cells are marked in the cells, respectively.

In this block, the frequency in the horizontal direction increases as it goes to the right side, the frequency in the vertical direction increases as it goes to the downside.

The block shown in Part (C) of FIG. 12 is an example of a block generated by the quantization unit 513.

This block is obtained by quantizing values of the block shown in Part (B) of FIG. 12.

In general, a high-frequency domain can be easily rounded to 0 through the quantization.

### Summary of Embodiments

The above-mentioned embodiments describe that the image compressing device 1 shown in FIG. 1, the image compressing device 2 shown in FIG. 4, or the image compressing device 3 shown in FIG. 9 are installed in a vehicle or the like, but may be used for any other application.

A program for implementing functions of the block generating unit 11, the discrete cosine transform unit 12, and the data adjusting unit 13 included in the image compressing device 1 shown in FIG. 1, the cutout unit 21, the block generating unit 11, the discrete cosine transform unit 12, and the data adjusting unit 13 included in the image compressing device 2 shown in FIG. 4, and the vertical division unit 31, the first image compressing unit 32a, the second image compressing unit 32b, and the vertical combination unit 33 included in the image compressing device 3 shown in FIG. 9 may be recorded in a computer-readable medium, and a process of parts production management may be performed by loading the program recorded in the recording medium into a computer system and executing the program. Here, “computer system” includes an OS and hardware such as a peripheral device. Furthermore, the “computer system” includes a WWW system having a home page providing environment (or display environment).

The “computer-readable recording medium” is a storage device such as a portable medium including a flexible disc, an optical-magnetic disc, a ROM, and a CD-ROM and a hard disk built in the computer system. Furthermore, the “computer-readable recording medium” includes a device storing a program for a predetermined time such as a volatile memory device (RAM) inside the computer system that becomes a server or a client in a case in which the program is transmitted through a network such as the Internet or a communication line such as a telephone line.

Furthermore, the program may be transmitted to other computer systems from the computer system in which the program is loaded in a memory device or the like through a transmission medium or carrier waves in a transmission medium. Here, the “transmission medium” means a medium having a function of information transmission such as a network (communication network) including the Internet or a communication line (communication wire) such as a telephone line. Furthermore, the program may implement a part of the above-described functions. The program may be a differential file (differential program) that may be combined with a program recorded in a computer system in advance.

While preferred embodiments of the invention have been described and illustrated above, it should be understood that the invention is not to be considered as being limited by the foregoing embodiments, and includes modifications within the scope of the concept of the invention.

What is claimed is:

1. An image compressing device comprising:
a block generating unit configured to divide an image into blocks having a predetermined size and to generate data corresponding to a plurality of blocks;
a discrete cosine transform unit configured to perform a discrete cosine transform on the data corresponding to the plurality of blocks generated by the block generating unit for each block and to generate frequency domain data of the image; and
a data adjusting unit configured to extract only components of a limited frequency domain from the frequency domain data of the image generated by the discrete cosine transform unit and to generate compressed data.

2. The image compressing device according to claim 1, further comprising a cutout unit configured to cut out a predetermined part of an image,
wherein the block generating unit divides the part of the image cut out by the cutout unit into blocks having a predetermined size and generates data corresponding to a plurality of blocks.

3. An image compressing device comprising:
a vertical division unit configured to divide an image into an upper part and a lower part;
a first image compressing unit configured to compress the image of the upper part output from the vertical division unit;
a second image compressing unit configured to compress the image of the lower part output from the vertical division unit; and
a vertical combination unit configured to combine compressed data of the image of the upper part generated by the first image compressing unit and compressed data of the image of the lower part generated by the second image compressing unit,
wherein the first image compressing unit includes
a first block generating unit configured to divide the image of the upper part output from the vertical division unit into blocks having a predetermined size and to generate data corresponding to a plurality of blocks,
a first discrete cosine transform unit configured to perform a discrete cosine transform on the data corresponding to the plurality of blocks generated by the first block generating unit for each block and to generate frequency domain data of the image, and
a first data adjusting unit configured to extract only components of a limited frequency domain from the frequency domain data of the image generated by the first discrete cosine transform unit and to generate compressed data,
wherein the second image compressing unit includes
a second block generating unit configured to divide the image of the lower part output from the vertical division unit into blocks having a predetermined size and to generate data corresponding to a plurality of blocks,
a second discrete cosine transform unit configured to perform a discrete cosine transform on the data corresponding to the plurality of blocks generated by the second block generating unit for each block and to generate frequency domain data of the image, and
a second data adjusting unit configured to extract only components of a limited frequency domain from the frequency domain data of the image generated by the second discrete cosine transform unit and to generate compressed data, and
wherein the limited frequency domain specified by the first data adjusting unit of the first image compressing unit and the frequency domain specified by the second data adjusting unit of the second image compressing unit are different from each other.

4. The image compressing device according to claim 1, wherein the image compressing device compresses an image captured by an in-vehicle camera.

5. The image compressing device according to claim 3, wherein the image compressing device compresses an image captured by an in-vehicle camera.

6. An image compressing method comprising:
a step of dividing an image into blocks having a predetermined size and generating data corresponding to a plurality of blocks;
a step of performing a discrete cosine transform on the data corresponding to the plurality of blocks for each block and generating frequency domain data of the image; and
a step of extracting only components of a limited frequency domain from the frequency domain data of the image and generating compressed data.

7. An image compressing program causing a computer to execute:
a block generating sequence of dividing an image into blocks having a predetermined size and generating data corresponding to a plurality of blocks;
a discrete cosine transform sequence of performing a discrete cosine transform on the data corresponding to the plurality of blocks generated in the block generating sequence for each block and generating frequency domain data of the image; and
a data adjusting sequence of extracting only components of a limited frequency domain from the frequency domain data of the image generated in the discrete cosine transform sequence and generating compressed data.
